(19) United States
(12) Patent Application Publication
(10) Pub. No.: US 2006/0064921 A1
(43) Pub. Date: Mar. 30, 2006

(54) Fishing tool for gripping & stripping

(76) Inventor: Jasper Buford, Vicksburg, MS (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/955,633

(22) Filed: Sep. 30, 2004

(51) Int. Cl. A01K 97/18

(52) U.S. Cl. 43/53.5

(57) ABSTRACT

A tool and method to remove a hook from a fish's mouth. The tool includes a pair of handles and a pair of elongated cylinders to grip a lower lip of a fish. The tool also includes a pair of blades adjacent to respective cylinders to cut and skin another fish.

### BACKGROUND OF THE INVENTION

1. Field of the Invention

The present invention is directed to an apparatus and method to grip a fish's mouth to remove a hook as well as to skin a fish such as a catfish.

2. Description of the Related Art

U.S. Pat. No. 4,559,853 discloses a device which can be used to grip a fish's lower lip. However, this device cannot be used to skin a fish as well as it contains no sharp parts.

U.S. Pat. No. 4,081,909 discloses orthodontic pliers which can be used to grip items. However, this device does not contain a sharp edge in order to use as a cutting tool.

What is needed is an improved tool to remove a hook from a fish's mouth as well as to skin a fish such as a catfish in the same tool.

### SUMMARY OF THE INVENTION

It is an aspect of the present invention to provide an improvement in fishing tools.

The above aspects can also be obtained by an apparatus that includes (a) a left handle and a right handle; a left elongated cylinder attached to the left handle and a right elongated cylinder attached to the right handle; a left blade attached to the left handle below the left elongated cylinder, and a right blade attached to the right handle below the right elongated cylinder.

The above aspects can also be obtained by a method that includes (a) removing a hook in a mouth of the first fish by gripping a lower lip of the first fish with a gripper and stripper tool; and (b) skinning a second fish with the gripper and stripper tool.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a top view of a gripper and stripper tool lying flat, according to an embodiment of the present invention;

FIG. 2 is a side view of a gripper and stripper tool, according to an embodiment of the present invention; and

FIG. 3 is a top view of a gripper and stripper tool lying vertically, according to an embodiment of the present invention.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present invention provides for a tool (a “gripper and stripper”) which can be used to grip a fish's mouth and remove a hook from the mouth. The present invention can also be used to skin a fish such as catfish. The tool can be made from metal, but any parts of it described herein can also be made from other materials such as plastic, etc.

When a fisherman catches a fish, the fisherman sometimes wishes to remove the hook from the fish's mouth and return the fish to the water. The gripper and stripper tool of the present invention allows the fisherman to grip the lower lip of the fish while he removes the hook. Because of the construction of the tool, the lower lip of the fish will not be damaged while it is being gripped by the tool.

The gripper and stripper tool can also be used to skin a fish such as a catfish.

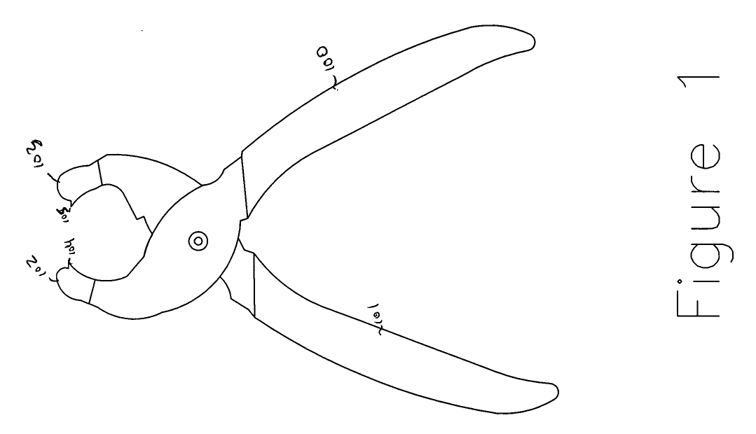

FIG. 1 is a top view of a gripper and stripper tool lying flat, according to an embodiment of the present invention.

A left handle 101 and a right handle 100 are used to grip and operate the tool. A left cylinder 102 and a right cylinder 103 is used to grip the fish's mouth. The cylinders are rounded (not sharp) such as to grip the fish's mouth without doing damage to the fish.

A left blade 104 and a right blade 105 cooperate when the handle is closed to strip the skin off a fish such as a catfish. The left blade 104 and right blade 105 are typically sharp to be able to perform the skinning. The left blade 104 is positioned below the left cylinder 102 while the right blade 105 is positioned below the right cylinder 103. The left blade 104 and the right blade 105 will typically not damage (or do minimal damage) to a fish while the gripper and stripper tool is being used to grip a fish's lower lip.

Thus, the gripper and stripper tool can be used to both remove a hook from a fish's mouth as well as to skin a fish.

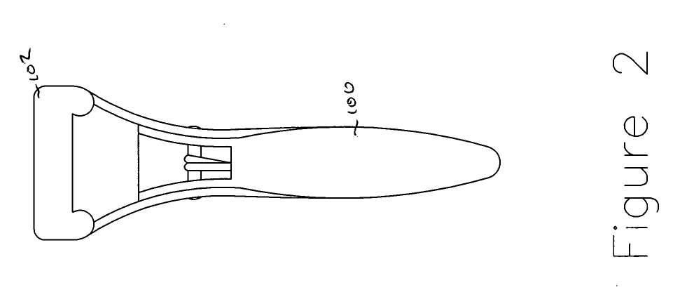

FIG. 2 is a side view of a gripper and stripper tool, according to an embodiment of the present invention.

The left handle 100 is connected to the left cylinder 102.

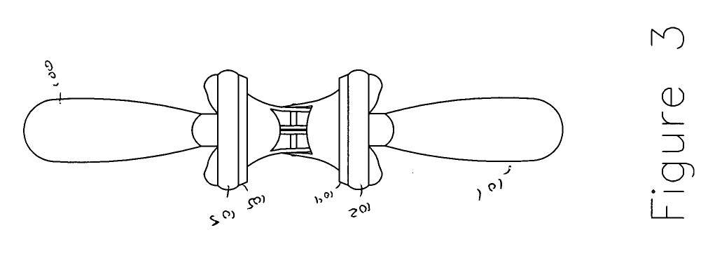

FIG. 3 is a top view of a gripper and stripper tool lying vertically, according to an embodiment of the present invention.

A left handle 101 and a right handle 100 are used to grip and operate the tool. A left cylinder 102 is connected to the left handle 101, and a right cylinder 103 is connected to the right handle 100. A left blade 104 and a right blade 105 are used to skin a fish.

As can be seen by the present invention, a single tool can be used to both remove a hook from a fish's mouth as well as strip the skin off a fish.

It is also noted that any and/or all of the above embodiments, configurations, variations of the present invention described above can mixed and matched and used in any combination with one another. Any claim herein can be combined with any others (unless the results are nonsensical).

Moreover, any description of a component or embodiment herein also includes hardware, software, and configurations which already exist in the prior art and may be necessary to the operation of such component(s) or embodiment(s).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A fishing tool, comprising:
a left handle and a right handle;
a left elongated cylinder attached an end of the left handle and a right elongated cylinder attached to an end of the right handle, the right elongated cylinder being separate from the left elongated cylinder and substantially parallel to the left elongated cylinder; and
a left blade attached to a right side of the left elongated cylinder, and a right blade attached to a left side of the right elongated cylinder, the left blade substantially parallel to and aligned with the right blade, and the left blade substantially parallel to the left elongated cylinder and the right blade substantially parallel to the right elongated cylinder

2. A fishing method, comprising:
providing a fishing tool comprising:
a left handle and a right handle;
a left elongated cylinder attached to an end of the left handle and a right elongated cylinder attached to an end of the right handle, the right elongated cylinder being separate from the left elongated cylinder and substantially parallel to the left elongated cylinder; and
a left blade attached to a right side of the left elongated cylinder, and a right blade attached to a left side of the right elongated cylinder, the left blade substantially parallel to and aligned with the right blade, and the left blade substantially parallel to the left elongated cylinder and the right blade substantially parallel to the right elongated cylinder
removing a hook in a mouth of a first fish by gripping a lower lip of the first fish with the fishing tool; and
skinning a second fish with the fishing tool.

3. A method as recited in claim 2, wherein the lower lip of the first fish is gripped by the left elongated cylinder and the right elongated cylinder.

4. A method as recited in claim 2, wherein skin on the second fish is cut by the left blade and the right blade.

5. A method as recited in claim 3, wherein skin on the second fish is cut by the left blade and the right blade.
